(19) United States
(12) Patent Application Publication
(10) Pub. No.: US 2025/0308034 A1
(43) Pub. Date: Oct. 2, 2025

(54) METHODS AND SYSTEMS FOR COMBINING IMAGES TO DETECT MOVING OBJECTS DEPICTED IN VIDEO CAMERA DATA

(71) Applicant: Verkada Inc., San Mateo, CA (US)

(72) Inventors: Song CAO, Foster City, CA (US); Suraj VATHSA, San Francisco, CA (US); Yi XU, Burlingame, CA (US); Yunchao GONG, Los Altos, CA (US)

(21) Appl. No.: 18/624,023

(22) Filed: Apr. 1, 2024

(51) Int. Cl. G06T 7/20; G06T 7/00; H04N 19/137; H04N 19/172; H04N 19/182; H04N 19/42

(52) U.S. Cl. CPC G06T 7/20; G06T 7/0002; H04N 19/137; H04N 19/172; H04N 19/182; H04N 19/42; G06T 2207/10016; G06T 2207/10024; G06T 2207/20081; G06T 2207/20084; G06T 2207/20212; G06T 2207/30168; G06T 2207/30232

(57) ABSTRACT

A non-transitory, processor-readable medium stores instructions that, when executed by a processor, cause the processor to receive a video stream including a plurality of video frames that depicts an object in motion. From the plurality of video frames, the instructions cause the processor to select a first video frame, a second video frame, and a third video frame. Based on the first video frame, a first channel of a pixel included in an image is encoded, to define a first encoded channel. The second video frame and the third video frame are used to encode, respectively, a second channel of the pixel and a third channel of the pixel, to define, respectively, a second encoded channel and a third encoded channel. A neural network is used to detect the object in motion based on the first encoded channel, the second encoded channel, and the third encoded channel.

### FIELD

The present disclosure generally relates to video surveillance, and more specifically, to systems and methods for combining images to detect moving objects based on video data.

### BACKGROUND

Image processing techniques exist for performing object detection. Object detection can include the detection of moving objects depicted in video data. Some known techniques for performing object detection can have degraded performance if the video data is captured in low lighting conditions, such as at nighttime. For example, video data captured in low lighting conditions using infrared image sensors can have poor resolution, contrast, etc., causing objects within the field of view of the camera to be missed by some known object detection techniques. A need exists, therefore, for improved object detection techniques.

### SUMMARY

In some embodiments, a non-transitory, processor-readable medium stores instructions that, when executed by a processor, cause the processor to receive a video stream including a plurality of video frames that depicts an object in motion. From the plurality of video frames, the instructions cause the processor to select a first video frame, a second video frame, and a third video frame. Based on the first video frame, a first channel of a pixel included in an image is encoded, to define a first encoded channel. The second video frame and the third video frame are used to encode, respectively, a second channel of the pixel and a third channel of the pixel, to define, respectively, a second encoded channel and a third encoded channel. A neural network is used to detect the object in motion based on the first encoded channel, the second encoded channel, and the third encoded channel.

In some embodiments, a non-transitory, processor-readable medium stores instructions that, when executed by a processor, cause the processor to receive a video stream including a plurality of video frames that depicts an object in motion. The instructions also cause the processor to select, from the plurality of video frames, a first video frame, a second video frame, and a third video frame. A multi-channel image is generated based on the first video frame, the second video frame, and the third video frame, and a neural network is used to detect the object in motion based on motion blur depicted in the multi-channel image.

In some embodiments, a non-transitory, processor-readable medium stores instructions that, when executed by a processor, cause the processor to receive a plurality of images associated with a plurality of video frames, the plurality of images including a first image, a second image, and a third image. A multi-channel image is generated based on the first image, the second image, and the third image, and, using as a ground truth image one of the first image, the second image, or the third image, a neural network is trained to detect an object in motion based on the multi-channel image.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 includes an example image that is generated based on three grayscale images and is provided as input to a neural network to identify an object, according to some embodiments.

FIG. 2 is a block diagram showing a multi-channel image generated from three single-channel images, according to some embodiments.

FIG. 3 is a system diagram showing an example implementation of a system for generating composite images and detecting moving objects, according to some embodiments.

FIG. 4 is a flow diagram showing a method for detecting an object in motion based on image channels encoded using video frames, according to some embodiments.

FIG. 5 is a flow diagram showing a method for detecting an object in motion based on motion blur depicted in a multi-channel image, according to some embodiments.

FIG. 6 is a flow diagram showing a method for training a neural network to detect an object in motion based on a multi-channel image and an image used to generate the multi-channel image, according to some embodiments.

### DETAILED DESCRIPTION

In some instances, video cameras can have a “night-mode” configuration, using infrared (IR) sensors to generate grayscale video frames during low lighting conditions (e.g., at night). These grayscale video frames can have poor contrast, causing people, vehicles, etc., to blend into the background of the depicted scene (e.g., background darkness). Furthermore, fewer and/or less diverse night-mode and/or grayscale images are typically available for use as training data as compared to, for example, color images captured in good lighting conditions. As a result, some known neural networks detect and/or classify objects (e.g., people, vehicles, etc.) depicted in grayscale images with reduced accuracy. At least some embodiments set forth herein address the foregoing issues by encoding a multi-channel image based on a plurality grayscale images. The multi-channel image can depict an artifact when a moving object is depicted within the plurality of grayscale images, and the multi-channel image can be provided as input to a neural network to detect the moving object.

At least one system, method, and/or apparatus described herein can encode a composite image based on a plurality of images (e.g., three images) selected from a plurality of video frames. The plurality of video frames can be captured from, for example, a camera having a fixed field of view (e.g., a stationary surveillance camera). The plurality of video frames can depict an object (e.g., a person, vehicle, animal, etc.) in motion, and each image from the plurality of images can depict the moving object at a different location within the image (e.g., relative to the center of the image) as compared to remaining images from the plurality of images. As a result of the object being depicted at a different position within the respective images from the plurality of images, the composite image, encoded based on the plurality of images, can depict an artifact (e.g., ghosting, noise, a smear, motion blur, and/or the like) associated with the moving object. Any nonmoving objects (e.g., stationary and/or background objects, such as trees, buildings, etc.) depicted in the plurality of images can be depicted within the composite image without an associated artifact or with an associated artifact that is below a predetermined threshold (e.g., a noise threshold). A neural network (e.g., a convolutional neural network (CNN) and/or the like) can, based on the artifact depicted in the composite image, (1) detect and/or classify the moving object and/or (2) classify and/or quantify the motion, as described herein.

The composite image (e.g., a multi-channel image) can have, for example, a plurality of channels (e.g., three channels), and each image from the plurality of images can be used to encode a different channel from the plurality of channels. In some implementations, the composite image can be associated with an RGB image format (e.g., an RGB color model), such that a red channel, a green channel, and a blue channel can collectively define a pixel from a plurality of pixels included in the composite image. A different set of red, green, and blue channels can define each pixel from the plurality of pixels (e.g., a first set of channels can be encoded to define a first pixel from the plurality of pixels, a second set of channels can be encoded to define a second pixel from the plurality of pixels, etc.). In some implementations, the composite image can be associated with an RYB color model, a CMY color model, a YUV color model, and/or any other image format that associates at least two channels with a pixel.

In some implementations, the plurality of images can be a plurality of grayscale images. For example, the plurality of video frames can be generated using a camera equipped with at least one infrared (IR) light emitting diode (LED). In low lighting conditions (e.g., at night, dusk, dawn, etc.), the camera can trigger the at least one IR LED to cause infrared light (e.g., an infrared wave) to be emitted from the IR LED and reflect off of an object and back to a sensor(s) (e.g., an infrared sensor(s)) included in the camera. Based on the brightness of the reflected infrared light at each infrared sensor, the camera can generate a grayscale image having a pixel for each infrared sensor.

As described above, the plurality of images can be selected from a plurality of video frames. For example, in some implementations, a first image (e.g., a first video frame), a second image (e.g., a second video frame), and a third image (e.g., a third video frame) can be selected from the plurality of video frames. It should be appreciated that, in some instances, these “first,” “second,” and “third” images are named based on their respective order of mention, within this text/disclosure, relative to each other and not, for example, their relative and/or absolute order in the plurality of video frames if the plurality of video frames are arranged in a sequence and/or series (e.g., arranged according to chronological order, order of capture, order indicated by timestamps associated with respective video frames, etc.). To further illustrate, if ten video frames in an example series of video frames are labelled, respectively, V1, V2. . . . V10, the first video frame does not necessarily have to be V1.

In some instances, a video frame can be selected from a plurality (e.g., a series) of video frames at a predefined interval. As a result, a first selected video frame can be temporally spaced by the predefined interval from a second selected video frame that is selected subsequent to the first selected video frame, and the second selected video frame can be temporally spaced by the predefined interval from a third selected video frame that is selected subsequent to the second selected video frame. For example, the predefined interval can be (or be within 20% of) a difference between the respective timestamps of the second video frame and the first video frame and/or a difference between the respective timestamps of the third video frame and the second videoframe. In some implementations, a video frame can be selected from the plurality (e.g., series) of video frames based on a predetermined interval of video frames (e.g., every video frame, every second video frame, every tenth video frame, and/or the like). In some instances, three video frames (e.g., three grayscale images) can be selected consecutively from the plurality of video frames.

A grayscale image can include a plurality of pixels, and each pixel from the plurality of pixels can be represented by, for example, 8-bits, 12-bits, 16-bits, and/or the like. A pixel represented by 8 bits, for example, can depict one of 256 possible shades. Each pixel in an RGB image (and/or the like) can be represented by 24-bits, 36-bits, 48-bits, and/or the like. Specifically, as described above, a pixel in an RGB image can be represented by three channels that are each associated with a different color, and each channel can be represented by 8-bits, 12-bits, 16-bits, and/or the like. As a result of an RGB pixel having more channels and/or a higher number of bits, an RGB image can include more information than a single channel, grayscale image. In some instances, therefore, an 8-bit pixel from a grayscale image can be represented by a single 8-bit channel of an RGB pixel, and an RGB pixel having three 8-bit channels can represent three 8-bit grayscale images.

In some instances, the plurality of video frames can include a plurality of color images (e.g., a plurality of RGB images and/or the like). For example, the plurality of video frames can be captured by a camera in daylight and/or illuminated conditions. The plurality of color images can be converted into a plurality of grayscale images to reduce the number of bits and/or channels associated with each pixel. Subsequently, a first grayscale image from said plurality of grayscale images can be used to reencode a first channel of a composite (e.g., RGB) image, and a second grayscale from said plurality of grayscale images can be used to reencode a second channel, different than the first channel, of the composite image.

After each pixel of the composite image has been encoded based on pixels from the respective grayscale images, the composite image can depict an artifact associated with an object in motion. For example, based on the object appearing in different locations within at least two of three grayscale images, a pixel of a first grayscale image from the at least two grayscale images can have a different encoding (e.g., bit value) compared to a pixel of a second grayscale image from the at least two grayscale images, where the pixel of the first grayscale image and the pixel of the second grayscale image have the same position within their respective image frames. When the pixel of the first grayscale image and the pixel of the second grayscale image are used to encode, respectively, a first channel of a composite image pixel and a second channel of the composite image pixel, these two channels can have different values, which can cause the compositive image pixel to depict a shade and/or color determined by, for example, the channel with the higher bit value.

Alternatively, in some instances, a pixel of the first grayscale image can have a same or similar (e.g., within 20%) bit value as compared to a pixel of the second grayscale image and a pixel of the third grayscale image. For example, each of these three pixels can depict the same portion of a non-moving object (e.g., a parked car, a tree, a building, etc.). When the three pixels image are used to encode, respectively, the first channel of the composite image pixel, the second channel of the composite image pixel, and the third channel of the composite image pixel, the three channels can have the same and/or similar bit values, such that the composite image pixel can depict the same or similar shade as compared to the respective pixels of the first grayscale image, the second grayscale image, and the third grayscale image. As a result, the composite image pixel can be excluded from a set of composite image pixels that depict an image artifact associated with object motion.

After the composite image has been encoded based on the first grayscale image, the second grayscale, and the third grayscale image, the composite image can be provided as input to a neural network that is configured to detect a moving object depicted in the first grayscale image, the second grayscale, and/or the third grayscale image. For example, the neural network can be configured to identify the moving object based on an artifact depicted in the composite image, where the artifact is a result of respective pixels of the first, second, and third grayscale images having the same and/or similar coordinates and different pixel values. In some implementations, the neural network can be a convolutional neural network (CNN) and/or a neural network configured for image processing. Based on the artifact, the neural network can be configured to (1) generate a bounding box to identify the object, (2) classify the object, (3) segment a pixel(s) that depicts the object, (4) classify motion (e.g., if the object is human, whether the object is walking, jogging, sprinting, etc.), and/or (5) quantify motion (e.g., determine a speed and/or direction of motion of the object).

To train the neural network, one of a first, second, or third grayscale image, used to generate and/or encode a composite image provided as input to the neural network, can be used as a ground truth image. For example, the third grayscale image can be an annotated image (e.g., an image associated with a label) that can be used as ground truth to train the neural network to identify an object in the composite image. In some implementations, the third grayscale image can be associated with a later timestamp as compared to the first grayscale image and the second grayscale image (e.g., the third grayscale image can be arranged subsequent to the first grayscale image and the second grayscale image within the series of video frames). By using the third grayscale image as a ground truth image, the neural network can generate a prediction for a previous image (e.g., the second grayscale image) without waiting for the previous image to be received at a processor executing the neural network.

In some instances, the neural network can be configured to receive as input and/or analyze multi-channel (e.g., RBG) images. As a result, while processing a single grayscale image (e.g., a single channel image), the neural network can use equivalent compute resources (e.g., processor resources, bandwidth, memory, and/or the like) as compared to processing a multi-channel image. Thus, in some instances, the neural network can process a composite image, encoded based on three grayscale images, without using more compute resources than what would be used to process a single grayscale image. Alternatively, in some instances, the neural network can process the composite image with less compute resources than what would be used to process the three grayscale images individually.

In response to the neural network detecting an object in motion, a signal can be sent to a remote compute device (e.g., a mobile device) associated with a user. The signal can include an alert, a representation of at least one grayscale image used to produce the composite image, a video clip based on the plurality of video frames, etc. In some instances, the signal can be sent to a remote compute device configured to perform additional image processing (e.g., post-processing).

In some instances, the composite image can be encoded at and/or the neural network can be executed at a compute device. The compute device, as part of, for example, a video camera system, can be local to a video camera or remote from a video camera. User inputs made via the compute device can be communicated to the video camera system and/or used by the video camera system during its operations, e.g., in the context of one or more video monitoring operations. Based on the composite image, an alert or alarm may be generated (optionally as part of the video monitoring operations) by the video camera system, the remote compute device, and/or the remote mobile compute device, and can be communicated to the user and/or to one or more other compute devices. The alert or alarm can be communicated, for example, via a software “dashboard” displayed via a GUI of one or more compute devices operably coupled to or part of the video camera system. The alert or alarm functionality can be referred to as, or as being part of, an “alarm system.”

As used herein, “object motion” can have an associated sensitivity, which may be user-defined/adjusted and/or automatically defined. A deviation of one or more parameters within or beyond the associated sensitivity may register as object motion. The one or more parameters can include, by way of non-limiting example, and with respect to a pixel(s) associated with the object, one or more of: a difference in a pixel appearance, a percentage change in light intensity for a region or pixel(s), an amount of change in light intensity for a region or pixel(s), an amount of change in a direction of light for a region or pixel(s), etc.

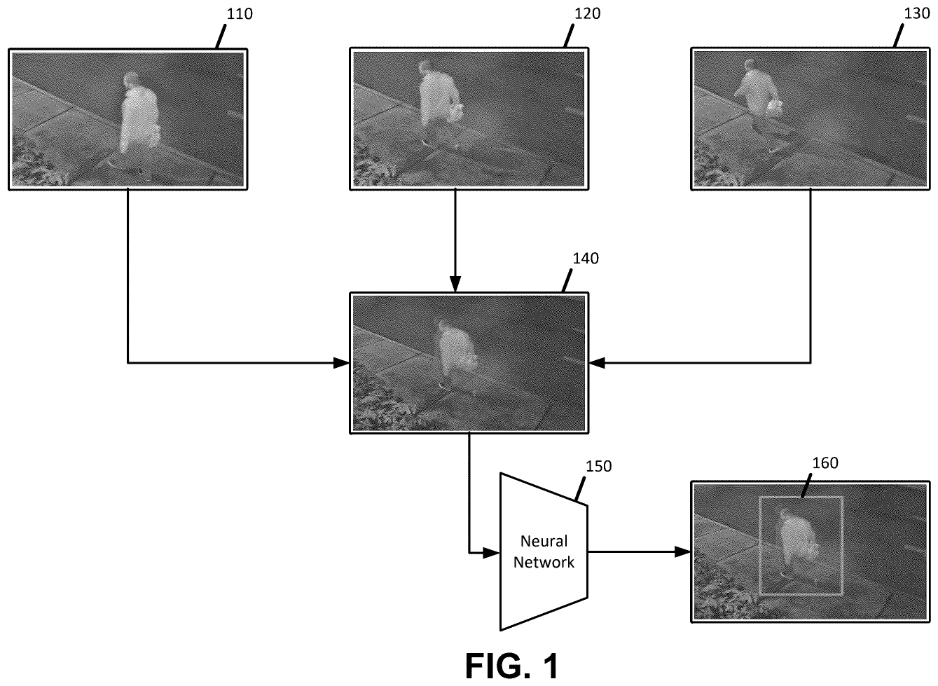

FIG. 1 includes a composite image 140 that is generated based on three grayscale images (110, 120, and 130) and is provided as input to a neural network 150 to identify an object, according to some embodiments. Each of these three grayscale images can be associated with a different capture time. For example, grayscale image 110 can be associated with a capture time t₁, grayscale image 120 can be associated with a capture time t₂, and grayscale image 130 can be associated with a capture time t₃. The grayscale images 110, 120, and 130 can be captured by the same video camera, which can be stationary and/or fixed. As shown in FIG. 1, the grayscale images 110, 120 and 130 can be used to encode pixel channels of the composite image 140. The grayscale images can be selected from a plurality of video frames included in video data, and, in some instances, the video data can be captured using a video camera. The composite image 140 can be associated with a multi-channel format, such as an RGB image format and/or the like. Encoding the composite image 140 (e.g., encoding channels of the composite image 140 to produce encoded channels) can refer to, for example, defining values (e.g., a bit value) for each channel of each multi-channel pixel in the composite image 140. A value defined for a specific channel of a specific multi-channel pixel can be based on (e.g., can be), for example, a value of a grayscale pixel from one of the grayscale images 110-130, where that grayscale pixel has a same or similar position and/or coordinates as the multi-channel pixel. Each of the grayscale images 110-130 can be associated with a different channel type (e.g., color), such that pixels from one of the grayscale images 110-130 are assigned to the same channel type (e.g., color) for pixels of the composite image 140.

By way of example, pixel values for grayscale image 110 can be “fed into” (e.g., used to define) R channels (and/or the like) of the composite image 140, pixel values for grayscale image 120 can be “fed into” (e.g., used to define) G channels (and/or the like) of the composite image 140, and pixel values for grayscale image 130 can be “fed into” (e.g., used to define) B channels (and/or the like) of the composite image 140. As such, a color artifact can result and/or be produced when, for a composite image pixel, the channel values differ (due to differing grayscale pixel values across the grayscale images 110-130), and the predominate channel value can predominate the color of the artifact.

Following encoding, the composite image 140 can depict a color artifact associated with a depicted moving object, and the composite image 140 can further depict background and/or non-moving objects (e.g., the sidewalk, road, etc.) in grayscale. The neural network 150 can be or include, for example, a CNN configured (e.g., structured) to accept multi-channel images, such as the composite image 140 and/or an image defined by channels commonly associated with three colors, as input. The CNN can be trained to detect an object based on the color artifact depicted in the composite image 140 and, in response to detecting the object, generate a bounding box 160 to identify a position and/or size of the object as depicted in the composite image 140. Optionally, the neural network 150 can generate, based on the color artifact, a classification for the object, a classification for the motion of the object, or a quantification for the motion of the object.

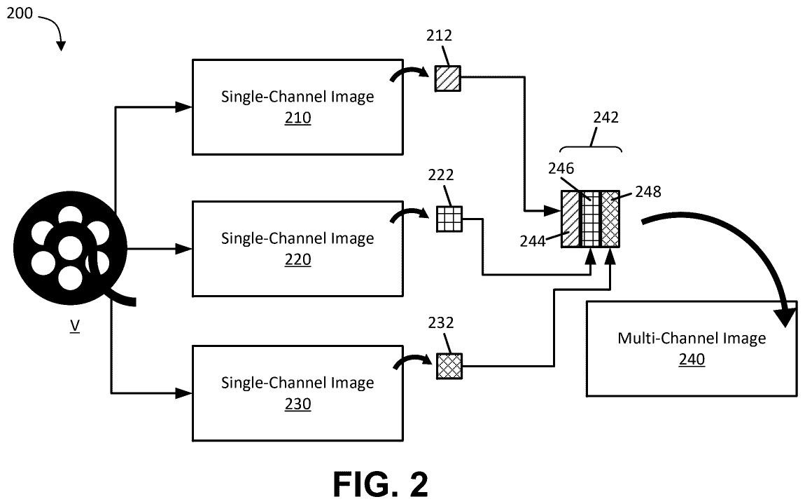

FIG. 2 is a block diagram showing a multi-channel image 240 (e.g., an RBG image and/or the like) generated from three single-channel images 210, 220, and 230, according to some embodiments. Each of the single-channel images 210, 220, and 230 can be selected from video data V, as described herein. To generate the multi-channel image 240, each pixel of the multi-channel image 240, such as pixel 242, can be encoded based on pixels from the single-channel images 210, 220, and 230 (e.g., pixel 212, pixel 222, and pixel 232, respectively). Within their respective images, the pixels 212, 222, 232, and 242 can have the same or similar coordinates, such that the pixels are associated with the same or similar location within their respective images. The pixel 242 can have three channels 244-248. The first channel 244 can be encoded based on the pixel 212 from the first single-channel image 210. The second channel 246 can be encoded based on the pixel 222 from the second single-channel image 220. The third channel 248 can be encoded based on the pixel 232 from the third single-channel image 230. Based on the encoded channels 244-248, the pixel 242 can depict (1) a shade and, (2) if a value of one encoded channel is different from at least one remaining encoded channel, a color. If the pixel 242 depicts a color, it can indicate that the pixel depicts an artifact associated with a moving object captured in the video data V.

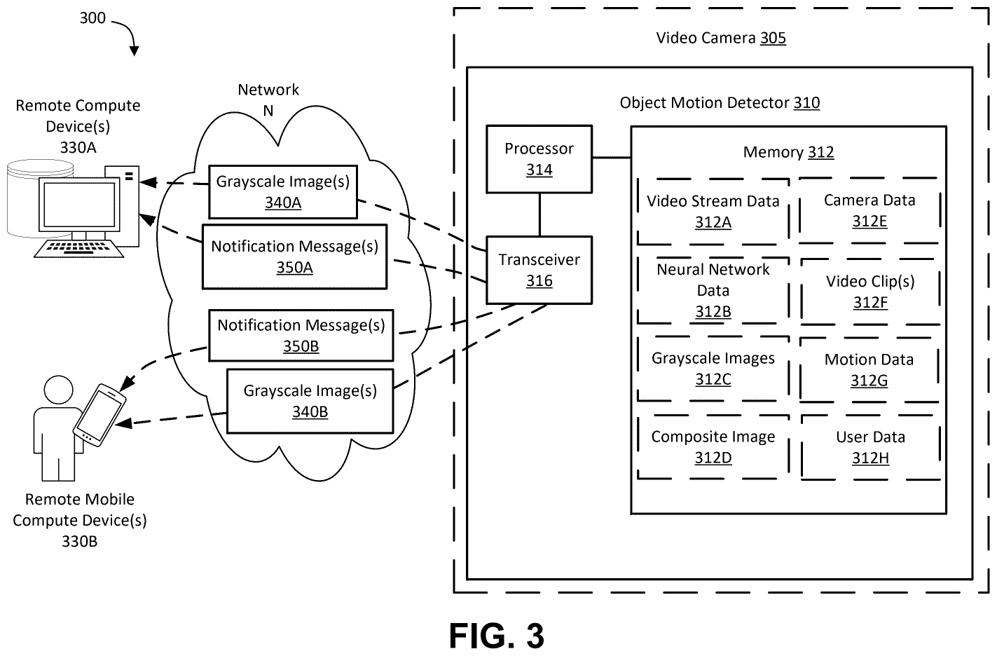

FIG. 3 is a system diagram showing an example implementation of an object detection system 300 for objects identified based on a video stream, according to some embodiments. As shown in FIG. 3, the object motion detector 310 includes a processor 314 operably coupled to a memory 312 and a transceiver 316. The object motion detector 310 is optionally located within, co-located with, located on, in communication with, or as part of a video camera 305. The memory 312 stores one or more of video stream data 312A, neural network data 312B, grayscale images 312C, composite images 312D, camera data 312E, video clip(s) 312F, motion data 312G, and user data 312H.

The video stream data 312A can include, by way of example only, one or more of video imagery, date/time information, stream rate, originating internet protocol (IP) address, etc. The neural network data 312B can include, by way of example only, one or more of neural network weights, neural network architecture data, neural network training data, and/or the like. The grayscale images 312C can include, by way of example, imagery data depicting an object generated using single-channel pixels and based on the video stream data 312A. The composite image 312D can include, by way of example, an image generated and/or encoded based on the grayscale images 312C.

The camera data 312E can include, by way of example only, one or more of camera model data, camera type, camera setting(s), camera age, and camera location(s). The video clip(s) 312F can include, by way of example, a series of temporally arranged images that can be optionally transmitted to a user in response to motion being detected based on the composited image 312D. The motion data 312G can include, by way of example, at least one of a bounding box generated by a neural network associated with the neural network data 312B, object classification data, motion classification data, or motion quantification data. The motion data 312G can further include a time and/or a number of sequential video frames that an object has been depicted and/or detected in. The motion data 312G can further include a time and/or a number of video frames since an object detection (e.g., a time that indicates an absence of object detection).

The user data 312H can include, by way of example only, one or more of user identifier(s), user name(s), user location(s), and user credential(s). The user data 312H can also include, by way of example, motion alert transmission frequency, image count per transmission and/or period of time, capture frequency, desired frame rate(s), sensitivity/sensitivities (e.g., associated with each from a plurality of parameters), notification frequency preferences, notification type preferences, camera setting preference(s), etc.

The object motion detector 310 and/or the video camera 305 is communicatively coupled, via the transceiver 316 and via a wired or wireless communications network “N,” to one or more remote compute devices 330A (e.g., including a processor, memory, and transceiver) such as workstations, desktop computer(s), or servers, and/or to one or more remote mobile compute devices 330B (e.g., including a processor, memory, and transceiver) such as mobile devices (cell phone(s), smartphone(s), laptop computer(s), tablet(s), etc.). During operation of the object motion detector 310, and in response to detecting an object and/or motion, notification message(s) 350A and 350B can be automatically generated and sent to one or both of, respectively, the remote compute device(s) 330A or the remote mobile compute device(s) 330B. The notification message(s) 350A and 350B can include, by way of example only, one or more of an alert, semantic label(s) representing the type(s) of object(s) and/or motion detected, time stamps associated with the grayscale images 312C, etc. Alternatively or in addition, grayscale image(s) 340A (e.g., a grayscale image selected from the grayscale images 312C) can be automatically sent to the remote compute device(s) 330A in response to detecting an object and/or motion. In some instances, grayscale image(s) 340B can be automatically selected from the grayscale images 312C and sent to the remote mobile compute device(s) 330B in response to detecting an object and/or motion.

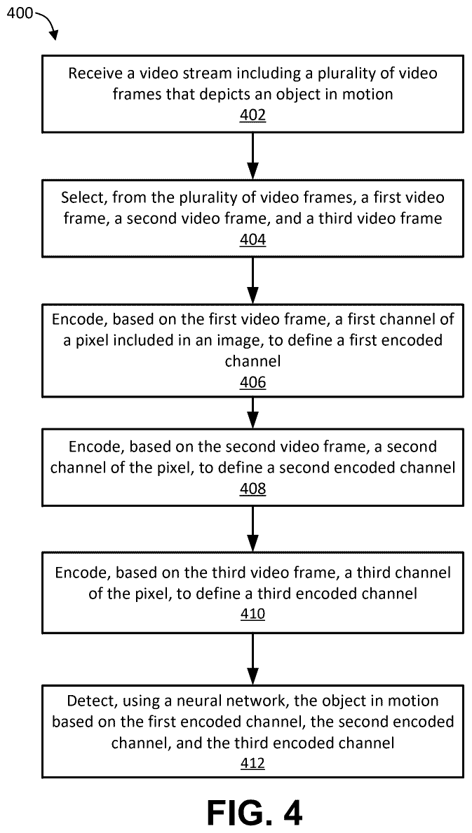

FIG. 4 is a flow diagram showing a method 400 for detecting an object in motion based on image channels encoded using video frames, according to some embodiments. The method 400 can be implemented, for example, using the object detection system 300 of FIG. 3. As shown in FIG. 4, the method 400, at 402, includes receiving a video stream including a plurality of video frames that depicts an object in motion. At 404, a first video frame, a second video frame, and a third video frame are selected from the plurality of video frames. At 406, based on the first video frame, a first channel of a pixel included in an image is encoded, to define a first encoded channel. The method 400 at 408 includes encoding, based on the second video frame, a second channel of the pixel, to define a second encoded channel. At 410, based on the third video frame, a third channel of the pixel is encoded, to define a third encoded channel. At 412, the method 400 includes detecting, using a neural network, the object in motion based on the first encoded channel, the second encoded channel, and the third encoded channel.

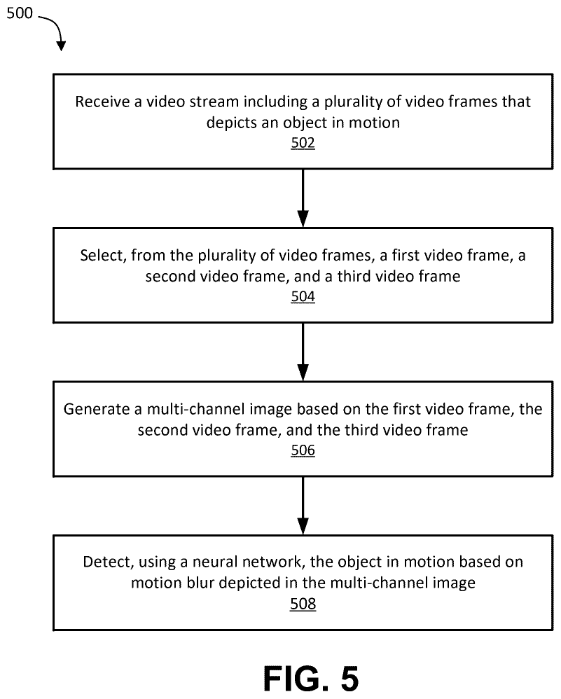

FIG. 5 is a flow diagram showing a method 500 for detecting an object in motion based on motion blur depicted in a multi-channel image, according to some embodiments. The method 500 can be implemented, for example, using the object detection system 300 of FIG. 3. As shown in FIG. 5, the method 500, at 502, includes receiving a video stream including a plurality of video frames that depicts an object in motion. At 504, a first video frame, a second video frame, and a third video frame are selected from the plurality of video frames. At 506, the method 500 includes generating a multi-channel image based on the first video frame, the second video frame, and the third video frame. At 508, using a neural network, the object in motion is detected based on motion blur depicted in the multi-channel image.

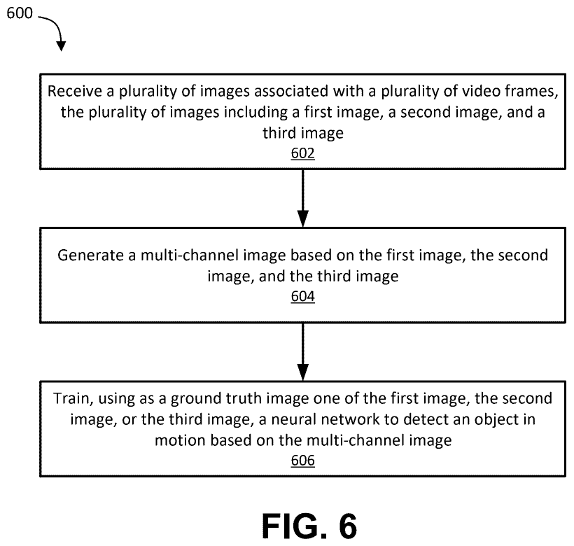

FIG. 6 is a flow diagram showing a method 600 for training a neural network to detect an object in motion based on a multi-channel image and an image used to generate the multi-channel image, according to some embodiments. The method 600 can be implemented, for example, using the cropped image generation system 300 of FIG. 3. As shown in FIG. 6, the method 600 includes receiving, at 602, a plurality of images associated with a plurality of video frames, the plurality of images including a first image, a second image, and a third image. At 604, a multi-channel image is generated based on the first image, the second image, and the third image. The method 600 also includes, at 606, training, using as a ground truth image one of the first image, the second image, or the third image, a neural network to detect an object in motion based on the multi-channel image.

In some embodiments, a non-transitory, processor-readable medium stores instructions that, when executed by a processor, cause the processor to receive a video stream including a plurality of video frames that depicts an object in motion. From the plurality of video frames, the instructions cause the processor to select a first video frame, a second video frame, and a third video frame. Based on the first video frame, a first channel of a pixel included in an image is encoded, to define a first encoded channel. The second video frame and the third video frame are used to encode, respectively, a second channel of the pixel and a third channel of the pixel, to define, respectively, a second encoded channel and a third encoded channel. A neural network is used to detect the object in motion based on the first encoded channel, the second encoded channel, and the third encoded channel.

In some implementations, each of the first video frame, the second video frame, and the third video frame can be associated with a different grayscale image from a plurality of grayscale images. Alternatively or in addition, in some implementations, the image can be an RGB image, and the neural network can be a convolutional neural network configured to process an RGB image. Alternatively or in addition, in some implementations, the first video frame, the second video frame, and the third video frame can be ordered consecutively within the plurality of video frames. Alternatively or in addition, in some implementations, the first video frame can be temporally spaced, by a predefined interval, from the second video frame within the video stream, and the second video frame can be temporally spaced, by the predefined interval, from the third video frame within the video stream. Alternatively or in addition, in some implementations, the image can depict an artifact associated with the object in motion, and the instructions to detect the object in motion can include instructions to detect, using the neural network, the object in motion based on the artifact depicted in the image.

In some embodiments, a non-transitory, processor-readable medium stores instructions that, when executed by a processor, cause the processor to receive a video stream including a plurality of video frames that depicts an object in motion. The instructions also cause the processor to select, from the plurality of video frames, a first video frame, a second video frame, and a third video frame. A multi-channel image is generated based on the first video frame, the second video frame, and the third video frame, and a neural network is used to detect the object in motion based on motion blur depicted in the multi-channel image.

In some implementations, each of the first video frame, the second video frame, and the third video frame can include a plurality of pixels, and for each of the first video frame, the second video frame and the third video frame, each pixel from the plurality of pixels for that video frame can be represented by a single channel. Alternatively or in addition, in some implementations, the instructions to generate the multi-channel image can include instructions to encode a first channel of each pixel of the multi-channel image based on the first video frame, to define a first encoded channel, encode a second channel of each pixel of the multi-channel image based on the second video frame, to define a second encoded channel, and encode a third channel of each pixel of the multi-channel image based on the third video frame, to define a second encoded channel. The instructions to detect the object in motion can include instructions to detect, using the neural network, the object in motion based on a plurality of channels of at least one pixel of the multi-channel image, the at least one pixel depicting the motion blur.

Alternatively or in addition, in some implementations, the multi-channel image can be an RGB image, and the instructions to encode the first channel of each pixel of the RGB image can include instructions to encode the first channel of each pixel of the RGB image based on an R channel of each pixel of the first video frame. The instructions to encode the second channel of each pixel of the RGB image can include instructions to encode the second channel of each pixel of the RGB image based on a G channel of each pixel of the second video frame. The instructions to encode the third channel of each pixel of the RGB image can include instructions to encode the third channel of each pixel of the RGB image based on a B channel of each pixel of the third video frame. Alternatively or in addition, in some implementations, the neural network can be a convolutional neural network (1) configured to process the multi-channel image and (2) trained based on a grayscale image. Alternatively or in addition, in some implementations, each of the first video frame, the second video frame, and the third video frame can include an associated color image, and the non-transitory, processor-readable medium can further store instructions to cause the processor to generate (1) a first grayscale image based on the first video frame, (2) a second grayscale image based on the second video frame, and (3) a third grayscale image based on the third video frame. The instructions to generate the multi-channel image can include instructions to generate the multi-channel image based on the first grayscale image, the second grayscale image, and third grayscale image. Alternatively or in addition, in some implementations, the motion blur can be a color artifact, and the multi-channel image can further depict a grayscale background.

In some embodiments, a non-transitory, processor-readable medium stores instructions that, when executed by a processor, cause the processor to receive a plurality of images associated with a plurality of video frames, the plurality of images including a first image, a second image, and a third image. A multi-channel image is generated based on the first image, the second image, and the third image, and using as a ground truth image one of the first image, the second image, or the third image, a neural network is trained to detect an object in motion based on the multi-channel image.

In some implementations, the neural network can be a convolutional neural network configured to process the multi-channel image. Alternatively or in addition, in some implementations, each of the first image, the second image, and the third image can be a grayscale image from a plurality of grayscale images. Alternatively or in addition, in some implementations, the ground truth image can be associated with a label. Alternatively or in addition, in some implementations, the multi-channel image can depict noise associated with the object in motion, and the instructions to train the neural network can include instructions to train the neural network to detect the object in motion based on the noise depicted by the multi-channel image. Alternatively or in addition, in some implementations, the first image can be temporally spaced, by a predefined interval and within the plurality of video frames, from the second image. The second image can be temporally spaced, by the predefined interval and within the plurality of video frames, from the third image. Alternatively or in addition, in some implementations, the instructions to generate the multi-channel image can include instructions to encode a first channel from three channels of each pixel of the multi-channel image based on the first image, to define a first encoded channel. The instructions to generate the multi-channel image can also include instructions to encode a second channel from the three channels of each pixel of the multi-channel image based on the second image, to define a second encoded channel. Additionally, the instructions to generate the multi-channel image can include instructions to encode a third channel from the three channels of each pixel of the multi-channel image based on the third image, to define a third encoded channel. The instructions to train the neural network can include instructions to train the neural network based on the three channels of each pixel of the multi-channel image.

All combinations of the foregoing concepts and additional concepts discussed here within (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A non-transitory, processor-readable medium storing instructions that, when executed by a processor, cause the processor to:
receive a video stream including a plurality of video frames that depicts an object in motion;
select, from the plurality of video frames, a first video frame, a second video frame, and a third video frame;
encode, based on the first video frame, a first channel of a pixel included in an image, to define a first encoded channel;
encode, based on the second video frame, a second channel of the pixel, to define a second encoded channel;
encode, based on the third video frame, a third channel of the pixel, to define a third encoded channel; and
detect, using a neural network, the object in motion based on the first encoded channel, the second encoded channel, and the third encoded channel.

2. The non-transitory, processor-readable medium of claim 1, wherein each of the first video frame, the second video frame, and the third video frame is associated with a different grayscale image from a plurality of grayscale images.

3. The non-transitory, processor-readable medium of claim 1, wherein:
the image is an RGB image; and
the neural network is a convolutional neural network configured to process an RGB image.

4. The non-transitory, processor-readable medium of claim 1, wherein the first video frame, the second video frame, and the third video frame are ordered consecutively within the plurality of video frames.

5. The non-transitory, processor-readable medium of claim 1, wherein:
the first video frame is temporally spaced, by a predefined interval, from the second video frame within the video stream; and
the second video frame is temporally spaced, by the predefined interval, from the third video frame within the video stream.

6. The non-transitory, processor-readable medium of claim 1, wherein:
the image depicts an artifact associated with the object in motion; and
the instructions to detect the object in motion include instructions to detect, using the neural network, the object in motion based on the artifact depicted in the image.

7. A non-transitory, processor-readable medium storing instructions that, when executed by a processor, cause the processor to:
receive a video stream including a plurality of video frames that depicts an object in motion;
select, from the plurality of video frames, a first video frame, a second video frame, and a third video frame;
generate a multi-channel image based on the first video frame, the second video frame, and the third video frame; and
detect, using a neural network, the object in motion based on motion blur depicted in the multi-channel image.

8. The non-transitory, processor-readable medium of claim 7, wherein:
each of the first video frame, the second video frame, and the third video frame includes a plurality of pixels; and
for each of the first video frame, the second video frame and the third video frame, each pixel from the plurality of pixels for that video frame is represented by a single channel.

9. The non-transitory, processor-readable medium of claim 7, wherein:
the instructions to generate the multi-channel image include instructions to:
encode a first channel of each pixel of the multi-channel image based on the first video frame, to define a first encoded channel,
encode a second channel of each pixel of the multi-channel image based on the second video frame, to define a second encoded channel, and
encode a third channel of each pixel of the multi-channel image based on the third video frame, to define a second encoded channel; and
the instructions to detect the object in motion include instructions to detect, using the neural network, the object in motion based on a plurality of channels of at least one pixel of the multi-channel image, the at least one pixel depicting the motion blur.

10. The non-transitory, processor-readable medium of claim 9, wherein:
the multi-channel image is an RGB image;
the instructions to encode the first channel of each pixel of the RGB image include instructions to encode the first channel of each pixel of the RGB image based on an R channel of each pixel of the first video frame;
the instructions to encode the second channel of each pixel of the RGB image include instructions to encode the second channel of each pixel of the RGB image based on a G channel of each pixel of the second video frame; and
the instructions to encode the third channel of each pixel of the RGB image include instructions to encode the third channel of each pixel of the RGB image based on a B channel of each pixel of the third video frame.

11. The non-transitory, processor-readable medium of claim 7, wherein the neural network is a convolutional neural network (1) configured to process the multi-channel image and (2) trained based on a grayscale image.

12. The non-transitory, processor-readable medium of claim 7, wherein:
each of the first video frame, the second video frame, and the third video frame includes an associated color image; and
the non-transitory, processor-readable medium further stores instructions to cause the processor to:
generate a first grayscale image based on the first video frame,
generate a second grayscale image based on the second video frame, and
generate a third grayscale image based on the third video frame; and
the instructions to generate the multi-channel image include instructions to generate the multi-channel image based on the first grayscale image, the second grayscale image, and third grayscale image.

13. The non-transitory, processor-readable medium of claim 7, wherein:
the motion blur is a color artifact; and
the multi-channel image further depicts a grayscale background.

14. A non-transitory, processor-readable medium storing instructions that, when executed by a processor, cause the processor to:
receive a plurality of images associated with a plurality of video frames, the plurality of images including a first image, a second image, and a third image;
generate a multi-channel image based on the first image, the second image, and the third image; and
train, using as a ground truth image one of the first image, the second image, or the third image, a neural network to detect an object in motion based on the multi-channel image.

15. The non-transitory, processor-readable medium of claim 14, wherein the neural network is a convolutional neural network configured to process the multi-channel image.

16. The non-transitory, processor-readable medium of claim 14, wherein each of the first image, the second image, and the third image is a grayscale image from a plurality of grayscale images.

17. The non-transitory, processor-readable medium of claim 14, wherein the ground truth image is associated with a label.

18. The non-transitory, processor-readable medium of claim 14, wherein:
the multi-channel image depicts noise associated with the object in motion; and
the instructions to train the neural network include instructions to train the neural network to detect the object in motion based on the noise depicted by the multi-channel image.

19. The non-transitory, processor-readable medium of claim 14, wherein:
the first image is temporally spaced, by a predefined interval and within the plurality of video frames, from the second image; and
the second image is temporally spaced, by the predefined interval and within the plurality of video frames, from the third image.

20. The non-transitory, processor-readable medium of claim 14, wherein:
the instructions to generate the multi-channel image include instructions to:
encode a first channel from three channels of each pixel of the multi-channel image based on the first image, to define a first encoded channel,
encode a second channel from the three channels of each pixel of the multi-channel image based on the second image, to define a second encoded channel, and
encode a third channel from the three channels of each pixel of the multi-channel image based on the third image, to define a third encoded channel; and
the instructions to train the neural network include instructions to train the neural network based on the three channels of each pixel of the multi-channel image.
